(19) United States
(12) Patent Application Publication
(10) Pub. No.: US 2004/0043811 A1
(43) Pub. Date: Mar. 4, 2004

(54) Gaming device and methods of use

(75) Inventors: Jerald C. Seelig, Absecon, NJ (US); Lawrence M. Henshaw, Hammonton, NJ (US)

Correspondence Address: IAN F. BURNS & ASSOCIATES, 1575 DELUCCHI LANE, SUITE 222, RENO, NV, 89502, US

(73) Assignee: Atlantic City Coin & Slot Service Company, Inc., Pleasantville, NJ (US)

(21) Appl. No.: 10/245,625

(22) Filed: Sep. 16, 2002

Related U.S. Application Data
(60) Provisional application No. 60/407,352, filed on Aug. 30, 2002.

(51) Int. Cl. A63F 9/24; A63F 13/00; G06F 17/00; G06F 19/00

(52) U.S. Cl. 463/16

(57) ABSTRACT

The specification discloses a gaming apparatus having at least one game device configured to allow a player to place a wager and play a game. The game device may also be a primary game device in certain embodiments. The gaming apparatus also has at least one display device in communication with the game device. The display device may be a bonus display in certain embodiments.

The display device may have at least one housing and at least one clock display attached to the housing. The clock display may have a plurality of prize symbols, a plurality of hands rotatably attached to the housing, and at least one clock mechanism coupled to the plurality of hands. The clock display may further have at least one controller in communication with the game device and the clock mechanism. When a prize event occurs, the controller may be configured to activate the clock mechanism, which selectively positions the hands, which then indicate at least one symbol on the clock display.

The specification further discloses that in certain embodiments, the housing has at least a portion resembling a miniature building and at least one three-dimensional figure coupled to the housing. The three-dimensional figure may have at least one animated element and at least one element mechanism coupled to the animated element. When a prize event occurs, the controller may activate the clock mechanism to cause the hands to indicate at least one symbol on the clock as well as display the element mechanism to cause the animated element to move.

### CROSS-REFERENCES TO RELATED PATENT APPLICATIONS

This application claims the benefit of U.S. Provisional Application No. 60/407,352, filed Aug. 30, 2002.

### FIELD OF INVENTION

The present invention relates to gaming devices. More particularly, the present invention relates to a gaming device that may have an animated three-dimensional figure and a clock mechanism for displaying a prize.

### BACKGROUND

A large variety of display devices have been developed to attract players to gaming devices and to entertain players while they are playing games. For example, Kelly et al. (U.S. Pat. No. 5,584,763) discloses an arcade game having a display face with indicia displayed thereon. The display face further includes pointers that rotate and point to the various indicia. A score is calculated based on the final positions of the pointers. A player must use skill in pressing a button at an appropriate time to try to stop the pointers in positions that would provide the player with the player's desired score.

One of the problems with the display device in Kelly et al. is that it is not compatible with gaming devices used in regulated gaming jurisdictions. Many gaming jurisdictions require the use of random number generators to determine the outcome of every game. The device disclosed in Kelly et al. allows players to use their skill to influence the outcome of the game. Therefore, the device disclosed in Kelley et al. cannot be used in many gaming jurisdictions and it is desirable to provide gaming devices that provide a more randomly generated outcome.

Another problem associated with Kelley et al. is that it does not utilize well-known objects. The applicants have found that players enjoy seeing well-known objects incorporated in gaming devices. When players see these objects in gaming devices, they are already comfortable and familiar with how they operate and they tend to trust the gaming devices more quickly. Therefore, players require less time to understand the game and the operation of the gaming device. Furthermore, commonly known, everyday objects can be very entertaining and attractive to players when they are cleverly incorporated into a gaming device.

Another problem associated with Kelly et al. is that it does not utilize animated figures. The applicants have also found that players enjoy seeing artificial objects, which are created to resemble the appearance and movements of their living counterparts, incorporated in gaming devices. Animated figures can also be very entertaining and attractive to players when they are cleverly incorporated into a gaming device.

In view of the foregoing, there is a need in the art for a gaming device that does not allow players' skills to influence the game outcome and, at the same time, provides a primary or bonus game that incorporates well-known objects and/or animated figures.

### SUMMARY

Advantages

The various embodiments of the present invention may, but do not necessarily, achieve one or more of the following advantages:

provide a highly attractive and entertaining device for displaying prizes;

provide a display device that offers various exciting and stimulating games to players and that may not require players' skill to influence the outcome of the games;

provide a gaming device that allows a player to play a bonus game shortly after a primary game, the bonus game having events accompanied with highly entertaining visuals and sound effects to stimulate the players' senses;

the ability to invite more players to play;

provide an additional element of surprise and excitement to conventional bonus games;

and provide more opportunities to earn bonus prizes; and

the ability to encourage players to play a gaming device longer.

These and other advantages of the various embodiments of the present invention may be realized by reference to the remaining portions of the specification, claims, and abstract.

### BRIEF DESCRIPTION OF CERTAIN ASPECTS OF THE PRESENT INVENTION

The applicants have provided a gaming apparatus having at least one game device configured to allow a player to place a wager and play a game. The game device may also be a primary game device in certain embodiments. The gaming apparatus also has at least one display device in communication with the game device. The display device may be a bonus display in certain embodiments.

The display device may have at least one housing and at least one clock display attached to the housing. The clock display may have a plurality of prize symbols, a plurality of hands rotatably attached to the housing, and at least one clock mechanism coupled to the plurality of hands. The clock display may further have at least one controller in communication with the game device and the clock mechanism. When a prize event occurs, the controller may be configured to activate the clock mechanism, which selectively positions the hands, which then indicate at least one symbol on the clock display.

In certain embodiments, the housing has at least a portion resembling a miniature building and at least one three-dimensional figure coupled to the housing. The three-dimensional figure may have at least one animated element and at least one element mechanism coupled to the animated element. When a prize event occurs, the controller may activate the clock mechanism to cause the hands to indicate at least one symbol on the clock as well as display the element mechanism to cause the animated element to move.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The preferred embodiments are shown in the accompanying drawings wherein:

FIG. 1 is substantially a front elevational view of an embodiment of the gaming apparatus of the present invention.

FIG. 2 is substantially a perspective view of a door where a three-dimensional figure may move in and out of the housing, the door being shown in an open position.

FIG. 3 is substantially a view of the three-dimensional figure initially positioned inside the housing and the mechanisms that animate the three-dimensional figure.

FIG. 4 is substantially a top schematic view of the three-dimensional figure in an extended position and the mechanisms that animate the three-dimensional figure.

FIG. 5 is substantially a view of an embodiment of a clock mechanism.

FIG. 6 is substantially another embodiment of a display device of the gaming apparatus of the present invention.

FIG. 7 is substantially a flow chart of a gaming method of the present invention.

FIG. 8 is substantially a flow chart of another gaming method of the present invention.

### DESCRIPTION OF THE PREFERRED EMBODIMENTS

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

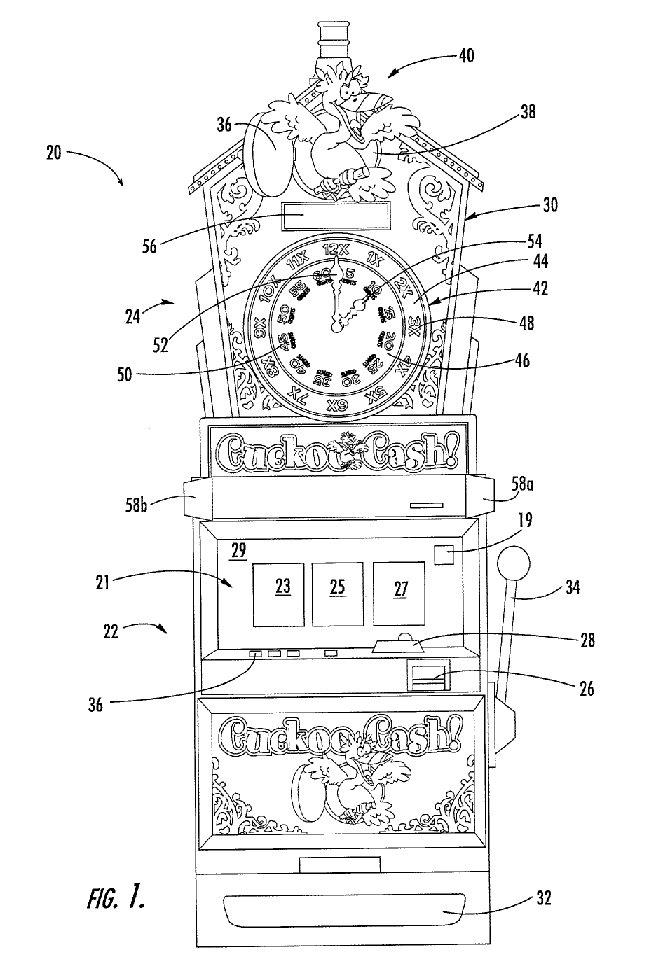

The present invention comprises a gaming apparatus, generally indicated by reference number 20. Referring to FIG. 1, gaming apparatus 20 has at least one gaming device 22 and at least one display device 24. In the preferred embodiment, one display device 24 is physically attached to one gaming device 22 and positioned on top of gaming device 22. However, in other embodiments (not shown), display device 24 may be remote and detached from, but in communication with, gaming device 22. Alternatively, gaming apparatus may have varying numbers of gaming devices 22 and bonus displays 24.

In the preferred embodiment, gaming device 22 is a gaming machine that allows a player to place a wager and play a game. Preferably, gaming device 22 is a slot machine having a plurality of reels with symbols, the symbols being displayed on their individual circumferences to communicate outcome of games. The reels may be physical reels or video images of reels displayed on a video screen. In other embodiments, gaming device 22 may be video poker games, video arcade games, video table games, and other gaming devices known in the art.

Gaming device 22 may include a wager acceptor for accepting wagers, such as a coin slot 28 or card reader 26. In addition, a payout mechanism (not shown) and a coin receptacle 32 may be provided for awarding prizes or for dispensing wagers to players cashing out. A handle 34 and button 36 may be provided for activating gaming device 22 to begin a game. A pay table (not shown) may further be provided to allow a player to see what symbol or combination of symbols provides a winning event. In at least one preferred embodiment, gaming device 22 may be an S Plus model gaming device manufactured by International Game Technology in Reno, Nev.

Gaming device 22 may further include a game outcome display 21 preferably positioned in front of gaming device 22 to face a player. Game outcome display 21 may utilize physical game reels 23, 25, and 27. Of course, the number of physical game reels may vary. Game reels 23, 25, and 27 may be coupled to a drive mechanism (not shown) of gaming device 22 to rotate the reels in a manner well known in the art. Each game reel 23, 25, and 27 preferably has a plurality of symbols (not shown) positioned on the circumference of each game reel 23, 25, and 27. Game reels 23, 25, and 27 may be positioned side-by-side to rotate around coincident axes with a portion of their individual circumferences facing the front of gaming device 22. A panel 29 preferably covers game reels 23, 25, and 27 such that only a portion of their individual circumferences is shown to the player. At least one symbol from any of game reels 23, 25, and 27 may be used to display a game outcome. At least one pay line (not shown) may be provided for the player to use in determining a game outcome based on the symbol or a combination of symbols positioned thereon. In an alternative embodiment, gaming outcome display 21 utilizes a video display (not shown) displaying images of game reels and images of at least one pay line.

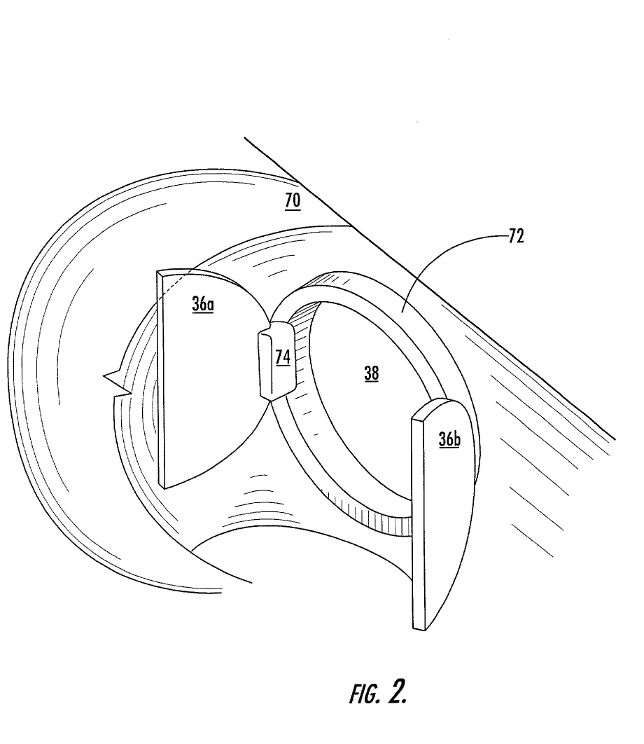

The preferred embodiment of a display device 24 of game apparatus 20 is also shown on FIG. 1. Display device 24 may have a housing 30, which may be made of plurality of walls defining an enclosure. Housing 30 may define a structure of display device 24 and may encase at least some of the components of display device 24. In the preferred embodiment, housing 30 is designed according to a theme of gaming apparatus 20. For example, the theme may be a cuckoo clock, in which case, housing 30 is shaped like a miniature building or a birdhouse. Miniature building may be any roofed and walled structure. Various designs may further be used for housing 30 besides a miniature building. In the example of a cuckoo clock, a portion of housing 30 may further define an opening 38 (see also FIG. 2) closed and opened by at least one door 36. As used herein, the term “door” refers to a moving barrier by which an opening is closed and opened. Opening 38 is preferably shaped as a circle.

Display device 24 may further have at least one three-dimensional FIG. 40 coupled to housing 30. In the preferred embodiment, three-dimensional FIG. 40 is preferably a cuckoo bird. Three-dimensional FIG. 40 has a length, a width, and a depth. Of course, various designs for a three-dimensional figure may be used depending on the theme of the gaming apparatus. Three-dimensional FIG. 40 may be animated by combination of at least one controller discussed below and at least one actuator discussed below. Three-dimensional FIG. 40 may be configured to move inside and outside housing 30 through opening 38, and door 36 is configured to open and close accordingly.

Display device 24 may further have a clock display 42 resembling a clock. In the preferred embodiment, clock display 42 preferably has a front surface divided into a first annular region 44 and a second annular region 46. First annular region 44 and second annular region 46 preferably have a common center. First annular region 44 preferably has a plurality of symbols 48 positioned thereon. First annular symbols 48 preferably represent various multipliers, such as 1× to 12×, which may be used to multiply a base amount. Second annular region 46 preferably also has a plurality of symbols 50 positioned thereon. Second annular symbols 50 preferably represent various base amounts, such as 25 coins or 30 coins. In other embodiments, the front surface of clock display 42 may just have a single region or may be divided into multiple regions of different shapes. Clock display 42 may further have different types of symbols that may have a variety of meanings associated with them.

Clock display 42 may further have a first clock hand 54 and a second clock hand 52 rotating on the same axis perpendicular to the front surface of clock display 42. Preferably, first clock hand 54 and a second clock hand 52 rotate around the center common to first annular region 44 and second annular region 46. First clock hand 54 is preferably configured to indicate a first annular symbol 48 or a multiplier positioned on first annular region 44. Second clock hand 52 is preferably configured to indicate a second annular symbol 50 or a base amount positioned on second annular region 46. In an alternative embodiment, one of the symbols, either on first or second annular region, may be a symbol representing an opportunity to play a game for free (not shown).

Display device 24 may further have a meter 56 for displaying a prize award. Meter 56 may be an LED meter. Meter 56 may be configured to show characters, such as a base amount indicated to by first clock hand 54, a multiplier indicated to by second clock hand 52, or a total prize amount, which may be a product of the base amount and the multiplier. Meter 56 may further show the calculation of the total amount. For example, meter 56 may show “10×4=40.” Meter 56 may further have blinking lights, synchronized lights, and other entertaining features known in the art. Meter 56 may be connected to a controller, which is discussed below and which may provide information for meter 56 to display.

Display device 24 or gaming apparatus 20 may have speakers 58a and 58b for producing an audio output. Speakers 58a and 58b may be in communication with a controller and sound card (not shown) of either gaming device 22 or display device 24. Sound card may store various pre-recorded sounds, preferably associated with three-dimensional FIG. 40. In the preferred embodiment, pre-recorded sound includes a cuckoo bird's call. Speakers 58a and 58b are preferably in communication with gaming device 22 or display device 24 preferably using serial communications. Display device 24 may also have graphical displays and lights to add attraction.

In an alternative embodiment, display device 24 may not have clock display 42. In another alternative embodiment, display device 24 may not have opening 38, door 36, and three-dimensional FIG. 40.

Referring now to FIG. 2, a portion of housing 30 is shown, particularly opening 38 defined by housing 30 and door 36 for covering the opening. In the preferred embodiment, a rim 72 is attached on the front surface of housing 30 and surrounds periphery of opening 38. Rim 72 may be made of aluminum, silicone, plastic, wood, or other suitable materials. Door 36 preferably has split doors 36a and 36b, and each door 36a and 36b may be attached to rim 72 using a clamp mechanism 74.

Housing 30 may further comprise a three-dimensional figure enclosure 70 for enclosing three-dimensional FIG. 40 (not shown in FIG. 2) and for isolating three-dimensional FIG. 40 from players or the public in general. Enclosure 70 is preferably spherical and transparent. Enclosure 70 may be made of glass, plastic, acrylic, polymers, fiberglass, and other materials known in the art.

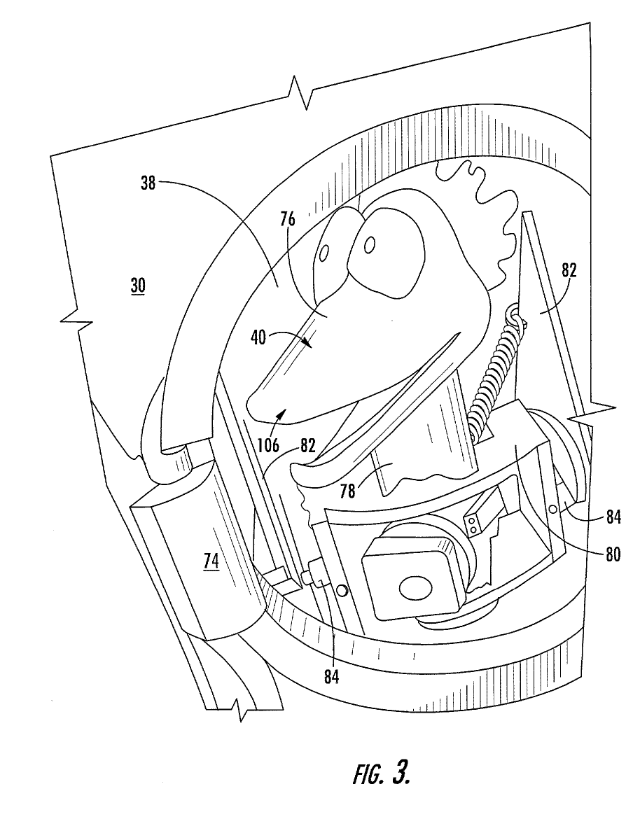

Referring now to FIG. 3, a three-dimensional FIG. 40 configured to move inside and outside housing 30 is shown. Three-dimensional FIG. 40 preferably has a head portion 76, a beak 106, and a body portion 78. Each portion 76, 106, and 78 may be animated or may be configured to move to action in a manner typically associated with the movement of three-dimensional FIG. 40 as if three-dimensional FIG. 40 has been given life. For example, three-dimensional FIG. 40 preferably is a cuckoo bird, and movements, such as making a cuckoo call indicated by movement of the beak, moving inside and outside the housing, and moving head portion 76, may be associated with the cuckoo bird. Three-dimensional FIG. 40 is preferably supported on a moveable carriage 80. Carriage 80 may be attached to a frame 82 by at least one shaft 84.

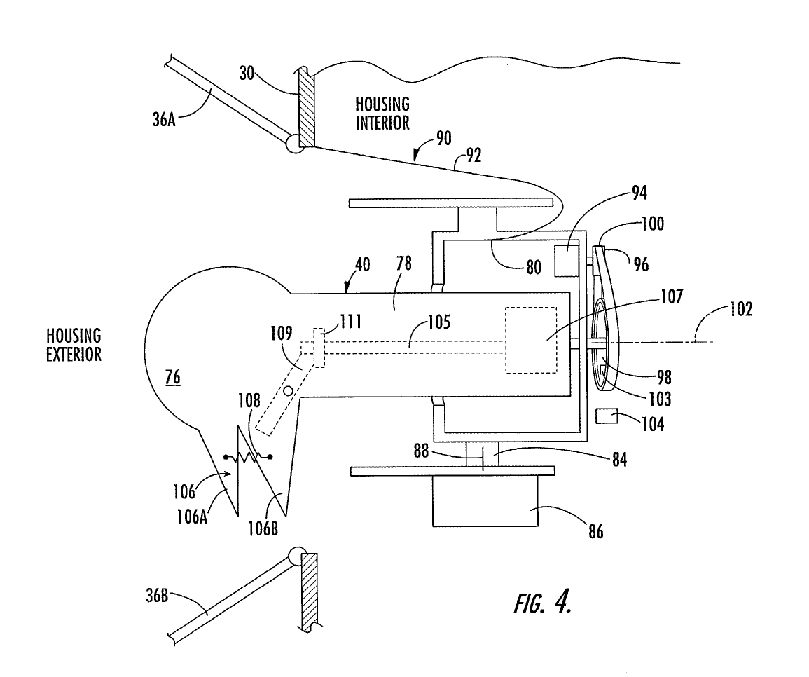

Referring now to FIG. 4, shaft 84 may be attached to a first motor 86, which causes shaft 84 to rotate around a rotational axis 88. Carriage 80 and three-dimensional FIG. 40 rotates with shaft 84. Three-dimensional FIG. 40 preferably moves from a position transverse from a horizontal plane and within the confines of housing 30 (hereinafter referred to as the “transverse position”) to a position substantially parallel to the horizontal plane wherein head portion 76 of three-dimensional FIG. 40 is disposed outside of the confines of housing 30 (hereinafter referred to as the “horizontal position”). Head portion 76 may be positioned outside the housing at an acute angle measured from a front wall of housing 40, appearing as if it is looking down below gaming device 22, and preferably at players (not shown) and clock display 42.

A door mechanism 90 for controllably opening and closing door 36 synchronous with movement of three-dimensional FIG. 40 may be attached between door 36 and carriage 80. Door mechanism 90 may include a biasing device, such as a spring or other biasing device known, may be used to bias door 36 in an open position. A control cable 92 preferably made of spectra polyethylene fiber cable or other suitable material may be used to counteract the biasing device and pull doors 36 closed. In this embodiment, one end of cable 92 is attached to door 36 while the other end of the cable is attached to carriage 80. As carriage 80 is made to rotate from the horizontal position to the transverse position by first actuator or motor 86, cable 92 pulls door 36 closed.

With continued reference to FIG. 4, a second actuator or motor 94 may be attached to a bottom of body portion 78 of three-dimensional FIG. 40. Second motor 94 may have at least one wheel 96 and 98 driven to rotate by a belt 100. Second motor 94 may cause three-dimensional FIG. 40 to rotate on a rotational axis 102. Second motor 94 is preferably activated by a controller, which is discussed below, to rotate three-dimensional FIG. 40 when body portion of three-dimensional FIG. 40 has moved to the horizontal position and head portion 76 of three-dimensional FIG. 40 has moved outside of housing 30. Second motor 94 therefore animates three-dimensional FIG. 40 such that the bird appears to be moving its head from one side to another and looking at various objects, such as the player, clock display 42, or meter 56 (not shown on FIG. 4).

Periphery of wheel 98 may have at least one notch 105 detectable by a sensor 104. In alternative embodiments, periphery of wheel may comprise portions with different reflective characteristics, such as physical holes or gaps or absorbent paint lines. Sensor may be an infrared source and detector. A controller may use data collected by sensor 104 pertaining to notch 103 to monitor, control, and position three-dimensional FIG. 40. An optical interrupt (not shown) may be provided to reset the position information pertaining to three-dimensional FIG. 40. Controller may animate and cause a portion of three-dimensional FIG. 40, preferably the bird's beak 106, to point to meter 56.

Beak 106 may have an upper beak component 106A and a lower beak component 106B. At least a portion of upper beak component 106A and lower beak component 106B may be made of rubber or other suitable material. A cable or spring 108 may connect upper beak component 106A and lower beak component 106B. Lower beak component 106B may pivot from an open position to a closed position relative to upper beak component 106A. Lower beak component 106B may be spring-loaded or biased by a biasing device, preferably by spring 108, to a closed position relative to upper beak component 106A. Lower beak component 106B may further have a lever 109, which may be made of water cut aluminum or other suitable material. Lever 109 may be coupled to a third actuator or motor 107 via a shaft 105. Shaft 105 comprises a cam 111 that drives lever 109 and causes lever 109 to oscillate around a pivot point 111. This causes lower beak 106B to oscillate, thereby animating three-dimensional FIG. 40. Third motor 107 may be connected to a controller discussed below for controlling the movement of lower beak 106B. Preferably, controller moves lower beak 106B synchronous with sounds the controller produces through speakers 58A and 58B (seen in FIG. 1). First motor 86, second motor 94, and third motor 107 may be stepper motors, solenoids, or other actuating devices known in the art.

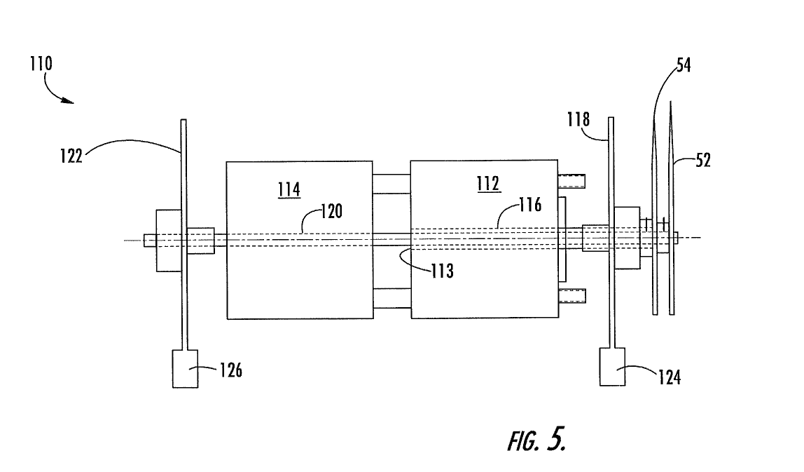

Referring now to FIG. 5, a clock mechanism 110 may be provided for selectively positioning first hand 54 and second hand 52 of clock display 42. In the preferred embodiment, clock mechanism 110 may have a first stepper motor 112 and second stepper motor 114. First stepper motor 112 may have a tube 116 that attaches to first clock hand 54. Tube 116 preferably has a hollow center and is positioned within a central bore 113 of first stepper motor 112. Second stepper motor 114 may have a shaft 120, which pass through first stepper motor 112 in tube 116 and attaches to second clock hand 52. Shaft 120 preferably protrudes more from first stepper motor 112 than tube 116, thereby providing space between second clock hand 52 and first clock hand 54. Clock hands 52 and 54 may be moved clockwise or counterclockwise and may operate independently of each other.

Clock mechanism 110 may further have at least one positioning system. A second positioning system 122 may be attached to end of shaft 120 opposite to the shaft end attached to second clock hand 52. The end of tube 116 opposite to the end attached to first clock hand 54 may be attached to first positioning system 118. First positioning system 118 and second positioning system 122 allow for tracking the position of the shafts. First positioning system 118 and second positioning system 122 may have encoders that convert shaft rotation into output pulses that may be counted by corresponding optical counters 124 and 126, respectively, to determine shaft revolution or shaft angle, which may be used by a controller in communication with optical counters 124 and 126 to determine positions of clock hands 52 and 54. Controller may further be in communication with clock mechanism 110 to selectively position clock hands 52 and 54 around clock display 42.

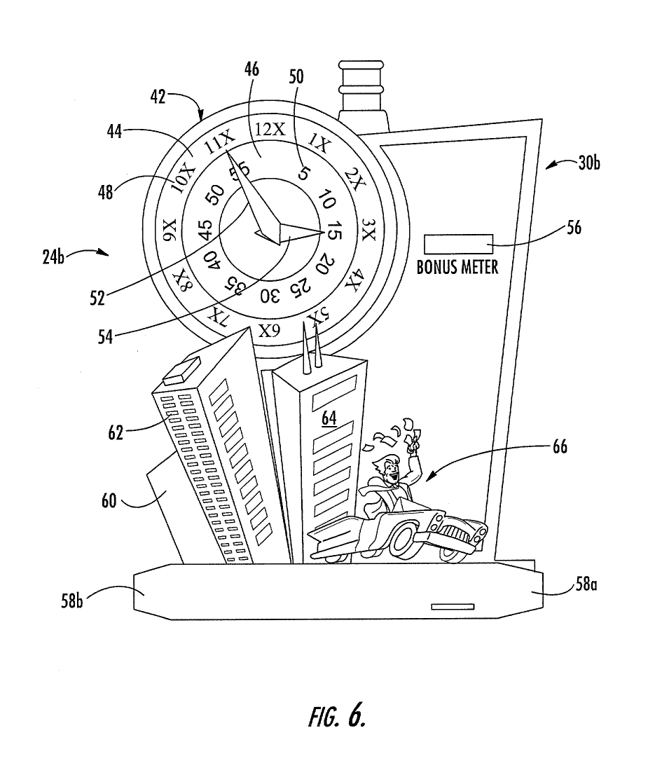

Referring now to FIG. 6, another embodiment of display device 24b is shown. Display device 24b may have clock display 42 similar to the clock display described above, including first clock hand 54, second clock hand 52, first annular region 44 with first annular symbols 48, and second annular region 46 with second annular symbols 50. Display device 24b also has meter 56 and speakers 58a and 58b similar to the meter and speakers described above.

Display device 24b may further have a housing 30b. Portions of housing 30b preferably have miniature buildings 60, 62, and 64, which, as a whole, resemble a downtown district. Housing 30b further displays at least one character 66, which may be designed according to various themes. In the embodiment shown in FIG. 6, the character resembles a person riding in a convertible type automobile around the downtown district. It is understood that the design for housing 30 and character 66 may vary.

Referring back to FIG. 1, gaming apparatus 20 is preferably controlled by a controller 19. Controller 19 may have one or more computers or processor boards. For example, individual computers or processor boards may be used for gaming device 22, display device 24, clock display 42, and three-dimensional FIG. 40. Of course, the number of controllers may vary. Controller 19 may be manufactured by Progressive Solutions in Carmichael, Calif. Controller 19 may have a core module manufactured by Z-World in Davis, Calif. Controller 19 may further have a soundboard by Cleverdevices in Syosset, N.Y. Other, equally suitable devices may be purchased from other manufacturers. It is recognized that controller 19 may be a single processor or processor board. Furthermore, it is also recognized that multiple controllers may be combined in a single processor or processor board.

Controller 19 preferably utilizes a random number generator. Random number generator produces a random or pseudo random number for each game. The outcome of the game may be determined by comparing the random number to a table of outcomes stored in a memory and accessed by controller 19. A number of different tables of outcomes may be used and different tables may be used for different games. The tables can be designed so that different prizes have different probabilities of being awarded. Examples of such designs are shown in U.S. Pat. No. 4,448,419, issued to Telnaes, and U.S. Pat. No. 5,456,465, issued to Durham, which are hereby incorporated by reference. Controller 19 causes game outcome display 21, e.g., game reels 23, 25, and 27, to show the outcome of the game that corresponds to the outcome of random number generator. It is recognized that gaming device 22 may operate in many other ways and still achieve the objects of the present invention.

Gaming device 22 preferably offers a primary game. Gaming device 22 may also be capable, via controller 19 or other control mechanism (not shown), of producing a bonus-activating event. This event may be many different types of events. For example, a bonus-activating event may comprise a game outcome such as displaying a particular symbol, e.g., a “bonus” symbol, or combination of symbols, such as three “7” symbols on reels 23, 25, 27. If the game being played is poker based, the bonus-activating event may be occurrence of a certain hand, such as a royal flush. Furthermore, a bonus-activating event may occur when a player accumulates a number of symbols or game outcomes over a number of separate game plays. For example, a bonus-activating event may occur when the player receives three “bonus” symbols during a period of time. The bonus-activating event may be based on an external event. For example, a bonus-activating event may occur when a group of players obtain a certain result. Sensors (not shown) may be provided external to gaming device 22 to detect external bonus-activating events.

In another embodiment, a bonus game controller (not shown) separate from controller 19 may be provided to detect when a bonus-activating event occurs in gaming device 22. Controller 19 may determine the outcome of each game, and when a bonus-activating outcome occurs, the controller 19 transmits a signal to the bonus game controller. Alternatively, the bonus game controller may periodically interrogate the controller 19.

When bonus-activating event occurs, display device 24 may offer a bonus game to player. It is recognized that display device 24 is not limited to offering a bonus game. Display device 24 may be used as a stand-alone device offering an independent game, or display device 24 may be used to provide a primary game.

In the preferred embodiment, display device 24 offers a game wherein when a bonus-activating event occurs, controller 19 may cause door mechanism 90 to open door 36. Controller 19 may further cause three-dimensional FIG. 40 to come out of opening 38 and to make an announcement through speakers 58a and 58b relating to the game or the bonus-activating event. As discussed above, sound or announcement may be associated with three-dimensional FIG. 40, such as a typical sound of a bird. Sounds may further be synchronized with the movement of three-dimensional FIG. 40, such as the movement of beak 106. Three-dimensional FIG. 40 may further instruct the player to activate clock display by pressing a button. When the player activates the button, controller 19 may cause first clock hand 54 and second clock hand 52 to start rotating, preferably in opposite directions, and to stop. Meter 56 preferably displays multiplier symbol indicated by first clock hand 54 and base amount symbol indicated by second clock hand 52. Meter 56 may further display the total bonus prize won by the player, which may be the product of the base amount and the multiplier. Additional lights and sounds may be added to make game apparatus 20 even more attractive. For example, three-dimensional FIG. 40 may be animated to announce the total prize to be awarded to the player. Additional movement of three-dimensional FIG. 40 may also occur, such as pointing beak 106 to the bonus prize and returning inside housing 30.

In another embodiment, display device 24 offers a game wherein when a bonus-activating event occurs, first clock hand 54 and second clock hand 52 may start rotating, preferably in opposite directions, and stop. Meter 56 preferably displays multiplier symbol indicated by first clock hand 54 and base amount symbol indicated by second clock hand 52. Meter 56 may further display the total bonus prize won by the player, which may be the product of the base amount and the multiplier.

The bonus prize may be determined by a random number generator (not shown) and a virtual pay table as described in U.S. Pat. No. 5,823,874, issued to Adams, which is hereby incorporated by reference. A simple pay table may appear as follows:

TABLE 1

| Random | |
|---|---|
| Number | Amount Paid |
| 0.00 to 0.50 | $10.00 |
| 0.51 to 0.75 | $5.00 |
| 0.76 to 0.95 | x 2 |
| 0.96 to 1.00 | $1,000.00 |

For example, if the random number generator produced 0.65, first clock hand 54 may stop at 1× and second clock hand 52 may stop at 10. Meter 56 may then display 1×10, or $10.00. The player will then be awarded $10.00.

The bonus selection process may be repeated to accumulate several bonus prizes that are added to form the award given to the game player. The bonus selection process can be repeated a predetermined number of times. For example, the bonus game could be repeated three times to accumulate an award. The present invention is not limited to the example pay table shown. Furthermore, different kinds of bonus prizes, besides monetary prizes, may be awarded. For example, the bonus prizes may be goods, services, or additional games. If the actual bonus prize is money, the amount of the bonus prize may be added to the player's credit meter (not shown) or the bonus prize may be dispensed from coin dispenser 32.

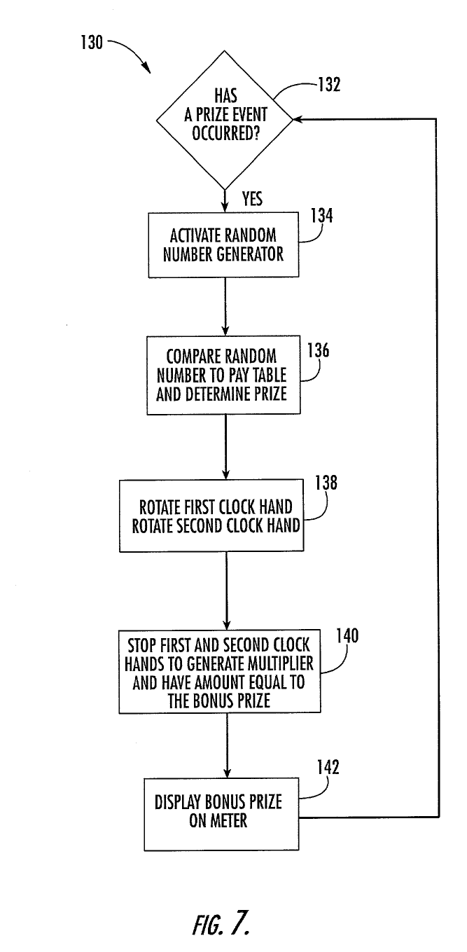

Referring now to FIG. 7, a gaming method 130 is shown wherein a controller described above (not shown in FIG. 5) determines whether a prize event has occurred in step 132. If a prize event has occurred, controller produces a random number at step 134. At step 136, a prize based on the random number is determined. At step 138, controller may rotate first clock hand 54 and second clock hand 52. At step 140, controller may cause first clock hand 54 and second clock hand 52 to stop at a base amount symbol and a multiplier symbol, respectively, the product of which would equal the prize from step 136. At step 142, the prize may then be displayed on meter 56. It is noted that step 138 may be repeated at a predetermined number of times to display the prize based on the random number. Base amount and multiplier may further be displayed on meter 56. Prize may be in the form of money, credits, goods, services, free games, vouchers, jackpots, progressive prizes, predetermined prizes, and other prizes known in the art.

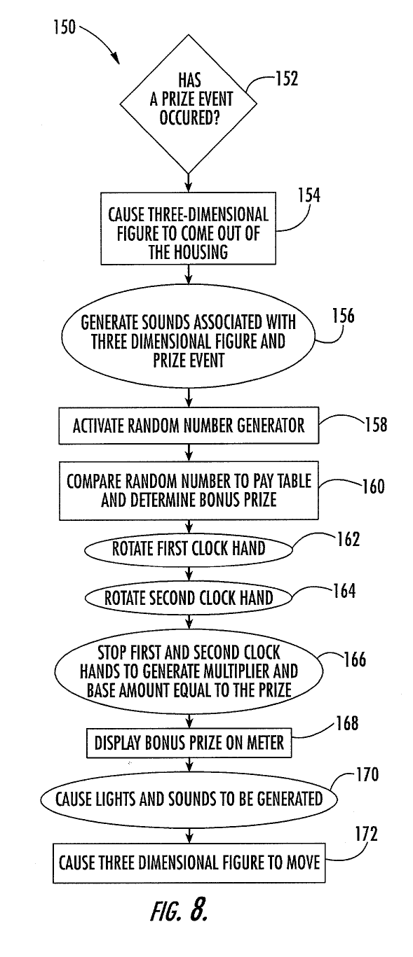

Referring now to FIG. 8, a gaming method 150 is shown wherein a controller determines whether a prize event has occurred in step 152. At step 154, if a prize event has occurred, controller causes three-dimensional FIG. 40 to move and come out of housing 30. At step 156, controller may generate sounds associated with three-dimensional symbol 40 and prize event. At step 158, controller produces a random number. At step 160, a prize based on the random number is determined. At steps 162 and 164, controller may rotate first clock hand 54 and second clock hand 52. At step 166, controller may cause first clock hand 54 and second clock hand 52 to stop at a base amount symbol and a multiplier symbol, respectively that would equal the prize from step 160. At step 168, the prize may then be displayed on meter 56. At step 170, controller may generate lights and sounds to create a festive prize event atmosphere. At step 172, three-dimensional FIG. 40 may move preferably inside housing 30. It is noted that the flowcharts in FIGS. 6 and 7 only shows a preferred embodiment. Many steps in the flowcharts may be varied, changed in order, or eliminated and still fall within the scope of the present invention.

CONCLUSION

It can thus be seen that with certain embodiments of the present invention, a display device has been provided that offer various exciting and stimulating games to players and that may not require players' skill to influence the outcome of the games. Certain embodiments of the present invention further provide a gaming device that allows a player to play a bonus game, which has events accompanied with highly entertaining visuals and sound effects to stimulate the players' senses, shortly after a primary game. Certain embodiments of the present invention have the ability to invite more players to play and encourage players to play longer.

Although the description above contains many specifications, these should not be construed as limiting the scope of the invention but as merely providing illustrations of some of presently preferred embodiments of this invention. Thus, the scope of the invention should be determined by the issued claims and their legal equivalents rather than by the examples given.

What is claimed is:

1. A gaming apparatus, comprising:
(A) at least one primary game device, the primary game device being configured to allow a player to place a wager and play a game; and
(B) at least one bonus display in communication with the primary game device, the bonus display comprising:
(a) at least one housing, the housing having at least a portion resembling a miniature building;
(b) at least one three-dimensional figure coupled to the housing, comprising:
(i) at least one animated element; and
(ii) at least one element mechanism coupled to the animated element, the element mechanism being configured to cause the animated element to move;
(c) at least one clock display attached to the housing, comprising:
(i) a plurality of bonus symbols;
(ii) a plurality of hands rotatably attached to the housing, each hand being configured to indicate at least one symbol; and
(iii) at least one clock mechanism coupled to the plurality of hands, the clock mechanism being configured to selectively position the hands; and
(d) at least one controller in communication with the primary game device, the element mechanism, and the clock mechanism, the controller being configured to activate the element mechanism and the clock mechanism when a bonus event occurs.

2. The gaming apparatus of claim 1, further comprising a speaker in communication with the controller, the speaker being configured to produce sound and the controller being configured to cause the speaker to produce the sound when a bonus event occurs.

3. The gaming apparatus of claim 2, wherein the sound produced by the speaker is a sound generally associated with the figure.

4. The gaming apparatus of claim 2, wherein the animated element moves in synchronization to the sound.

5. The gaming apparatus of claim 2 wherein the sound communicates bonus information to the player.

6. The gaming apparatus of claim 1, wherein the bonus display further comprises:
(A) at least one opening in the housing;
(B) at least one door attached to the housing adjacent to the opening, the door at least partially covering the opening when the door is in a closed position;
(C) at least one door mechanism attached to the door and in communication with the controller, the door mechanism being configured to at least cause the door to move from the closed position to an open position, wherein the controller is configured to activate the door mechanism when a bonus event occurs.

7. The gaming apparatus of claim 6, wherein the figure is positioned inside the housing adjacent to the opening, wherein the element mechanism causes the animated element to extend through the opening.

8. The gaming apparatus of claim 1, wherein the bonus symbols comprise at least one base symbol and at least one multiplier symbol, wherein at least one hand may be positioned to indicate the base symbol and the other hand may be positioned to indicate the multiplier symbol, wherein the player is awarded the product of the base symbol and the multiplier symbol when a bonus event occurs.

9. The gaming apparatus of claim 8 wherein the base symbol is positioned on a first annular region and the multiplier symbol is positioned on a second annular region.

10. The gaming apparatus of claim 9 wherein the first and second annular regions have a common center, wherein the hands are positioned to rotate around the center.

11. A gaming apparatus, comprising:
(A) at least one game device, the game device being configured to allow a player to place a wager and play a game; and
(B) at least one display device in communication with the game device, the display device comprising:
(a) at least one housing, the housing having at least a portion resembling a miniature building;
(b) at least one three-dimensional figure coupled to the housing, comprising:
(i) at least one animated element; and
(ii) at least one element mechanism coupled to the animated element, the element mechanism being configured to cause the animated element to move;
(c) at least one clock display attached to the housing, comprising:
(i) a plurality of prize symbols;
(ii) a plurality of hands rotatably attached to the housing, each hand being configured to indicate at least one symbol; and
(iii) at least one clock mechanism coupled to the plurality of hands, the clock mechanism being configured to selectively position the hands; and
(d) at least one controller in communication with the game device, the element mechanism, and the clock mechanism, the controller being configured to activate the element mechanism and the clock mechanism when a prize event occurs.

12. The gaming apparatus of claim 11, further comprising a speaker in communication with the controller, the speaker being configured to produce sound and the controller being configured to cause the speaker to produce the sound when a prize event occurs.

13. The gaming apparatus of claim 12, wherein the sound produced by the speaker is a sound generally associated with the figure.

14. The gaming apparatus of claim 12, wherein the animated element moves in synchronization to the sound.

15. The gaming apparatus of claim 12, wherein the sound communicates prize information to the player.

16. The gaming apparatus of claim 11, wherein the display device further comprises:
(A) at least one opening in the housing;
(B) at least one door attached to the housing adjacent to the opening, the door at least partially covering the opening when the door is in a closed position;
(C) at least one door mechanism attached to the door and in communication with the controller, the door mechanism being configured to at least cause the door to move from the closed position to an open position, wherein the controller is configured to activate the door mechanism when a prize event occurs.

17. The gaming apparatus of claim 16, wherein the figure is positioned inside the housing adjacent to the opening, wherein the element mechanism causes the animated element to extend through the opening.

18. The gaming apparatus of claim 11, wherein the prize symbols comprise at least one base symbol and at least one multiplier symbol, wherein at least one hand may be positioned to indicate the base symbol and the other hand may be positioned to indicate the multiplier symbol, wherein the player is awarded the product of the base symbol and the multiplier symbol when a prize event occurs.

19. The gaming apparatus of claim 18, wherein the base symbol is positioned on a first annular region and the multiplier symbol is positioned on a second annular region.

20. The gaming apparatus of claim 19, wherein the first and second annular regions have a common center, wherein the hands are positioned to rotate around the center.

21. A gaming apparatus, comprising:
(A) at least one game device, the game device being configured to allow a player to place a wager and play a game; and
(B) at least one display device in communication with the game device, the display device comprising:
(a) at least one housing;
(b) at least one clock display attached to the housing, comprising:
(i) a plurality of prize symbols;
(ii) a plurality of hands rotatably attached to the housing, each hand being configured to indicate at least one symbol; and
(iii) at least one clock mechanism coupled to the plurality of hands, the clock mechanism being configured to selectively position the hands; and
(c) at least one controller in communication with the game device and the clock mechanism, the controller being configured to activate the clock mechanism when a prize event occurs.

22. The gaming apparatus of claim 21, wherein the prize symbols comprise at least one base symbol and at least one multiplier symbol, wherein at least one hand may be positioned to indicate the base symbol and the other hand may be positioned to indicate the multiplier symbol, wherein the player is awarded the product of the base symbol and the multiplier symbol when a prize event occurs.

23. The gaming apparatus of claim 22, wherein the base symbol is positioned on a first annular region and the multiplier symbol is positioned on a second annular region.

24. The gaming apparatus of claim 24, wherein the first and second annular regions have a common center, wherein the hands are positioned to rotate around the center.

25. The gaming apparatus of claim 21, wherein the clock mechanism comprises:
(A) a first motor having a central bore and a first drive shaft positioned in the bore, the first drive shaft having a hollow center, a first hand of the plurality of the hands being attached to the first drive shaft, wherein the first motor moves the first hand by rotating the first drive shaft; and
(B) a second motor having a second drive shaft extending through the bore and the hollow center of the first drive shaft, a second hand of the plurality of hands being attached to the second drive shaft, wherein the second motor moves the second hand by rotating the second drive shaft.

26. A method of playing a game, comprising:
(A) allowing a player to place a wager;
(B) allowing a player to play a game;
(C) producing a prize event;
(D) animating a three-dimensional figure;
(E) rotating a first hand around an axis to a position to indicate a first prize symbol; and
(F) rotating a second hand around the axis to a position to indicate a second prize symbol.

27. The method of claim 26, further comprising providing at least one housing, the housing having at least a portion resembling a miniature building.

28. The method of claim 27, wherein the housing comprises at least one opening in the housing and at least one door coupled to the housing adjacent to the opening, the door at least partially covering the opening when the door is in a closed position, further comprising moving the door from a closed position to an open position.

29. The method of claim 28, wherein the step of animating the three dimensional figure comprises extending the figure out of the opening.

30. A method of playing a game, comprising:
(A) allowing a player to place a wager;
(B) allowing the player to play a game;
(C) producing a prize event;
(D) rotating a first hand around an axis to a position to indicate a first prize symbol; and
(E) rotating a second hand around the axis to a position to indicate a second prize symbol.

31. The method of claim 30, wherein at least one of the first and second prize symbols is a base symbol and at least one of the first and second prize symbols is a multiplier symbol, further comprising awarding the product of the first and second prize symbols to the player.

32. The method of claim 30 further comprising animating a three-dimensional figure.

33. The method of claim 32, further comprising generating a sound.

34. The method of claim 33, wherein the sound is a sound generally associated with the figure.

35. The method of claim 33, wherein the three-dimensional figure moves in synchronization to the sound.

36. A gaming device, comprising:
(A) gaming means for allowing a player to place a wager and play a game;
(B) a plurality of symbol means for communicating a prize;
(C) a plurality of hand means for indicating at least one symbol means;
(D) position means for positioning the hand means;
(E) controller means for causing the positioning means to position the hand means;

37. The gaming device of claim 36, further comprising:
(A) three-dimensional figure means for entertaining a player; and
(B) animation means for animating the three-dimensional figure means.

38. The gaming device of claim 36, further comprising speaker means for generating sounds.
